(19) United States
(12) Patent Application Publication
(10) Pub. No.: US 2014/0210673 A1
(43) Pub. Date: Jul. 31, 2014

(54) DUAL-BAND ANTENNA OF WIRELESS COMMUNICATION APPARATUS

(71) Applicant: Realtek Semiconductor Corp., Hsinchu (TW)

(72) Inventors: Sy-been WANG, Zhubei City (TW); Chih-pao LIN, Zhubei City (TW); Ching-Wei LING, Zhubei City (TW)

(73) Assignee: Realtek Semiconductor Corp., Hsinchu (TW)

(21) Appl. No.: 14/154,394

(22) Filed: Jan. 14, 2014

(30) Foreign Application Priority Data
Jan. 29, 2013 (TW) 102103371

(51) Int. Cl. H01Q 5/00

(52) U.S. Cl. CPC H01Q 5/001
USPC 343/700 MS

(57) ABSTRACT

A dual-band antenna of a wireless communication apparatus includes a first radiation part for receiving or transmitting signals at a first frequency band; a second radiation part for generating a coupling effect together with the first radiation part to receive or transmit signals at a second frequency band having a center frequency lower than a center frequency of the first frequency band, wherein the second radiation part comprises multiple radiation sections, and at least one of the multiple radiation sections is positioned on a first plane; a feeding element for coupling with a signal receiving terminal of the wireless communication apparatus; and a shorting element for coupling with a fixed-voltage region of the wireless communication apparatus. The first radiation part does not physically contact with the second radiation part, and at least a portion of the first radiation part is not positioned on the first plane.

### CROSS-REFERENCE TO RELATED APPLICATIONS

This application claims the benefit of priority to Patent Application No. 102103371, filed in Taiwan on Jan. 29, 2013; the entirety of which is incorporated herein by reference for all purposes.

### BACKGROUND

The present disclosure generally relates to an antenna of a wireless communication apparatus, and more particularly, to a miniaturized dual-band antenna with a wide bandwidth.

An antenna is an important component of a wireless communication apparatus, but it often occupies considerable area and volume of the circuit module. With the increasing demand on lighter, thinner, and smaller wireless communication devices, the volume of the antenna has to be further reduced for meeting the trend of device miniaturization.

Some wireless communication apparatuses are required to support transmitting/receiving signals at multiple frequency bands, such as 2.4 GHz band and 5 GHz band. In order to transmit/receive wireless signals at multiple frequency bands, multiple antennas have to be installed in a conventional wireless communication apparatus. However, it is difficult to reduce the overall volume of the wireless communication apparatus because the required space for arranging multiple antennas is difficult to be reduced.

### SUMMARY

An example embodiment of a dual-band antenna of a wireless communication apparatus is disclosed, comprising: a first radiation part, configured to operably receive or transmit signals at a first frequency band; a second radiation part, configured to operably generate a coupling effect together with the first radiation part to receive or transmit signals at a second frequency band having a center frequency lower than a center frequency of the first frequency band, wherein the second radiation part comprises multiple radiation sections, and at least one of the multiple radiation sections is positioned on a first plane; a feeding element, coupled with the first radiation part, for coupling with a signal receiving terminal of the wireless communication apparatus; and a shorting element, coupled with the second radiation part, for coupling with a fixed-voltage region of the wireless communication apparatus; wherein the first radiation part does not physically contact with the second radiation part, and at least a portion of the first radiation part is not positioned on the first plane.

Both the foregoing general description and the following detailed description are examples and explanatory only, and are not restrictive of the invention as claimed.

### BRIEF DESCRIPTION OF THE DRAWINGS

FIG. 1 shows a simplified schematic diagram of a wireless communication apparatus according to one embodiment of the present disclosure.

FIG. 2 shows a simplified top view of the wireless communication apparatus of FIG. 1 according to one embodiment of the present disclosure.

FIG. 3 shows a simplified schematic diagram illustrating a method for producing a second radiation part in FIG. 1 according to one embodiment of the present disclosure.

FIG. 4 shows a simplified schematic diagram of operating characteristics of a dual-band antenna in FIG. 1 according to one embodiment of the present disclosure.

FIG. 5 shows a simplified schematic diagram of a wireless communication apparatus according to another embodiment of the present disclosure.

FIGS. 6-7 show simplified schematic diagrams of the second radiation part according to several embodiments of the present disclosure.

### DETAILED DESCRIPTION

Reference is made in detail to embodiments of the invention, which are illustrated in the accompanying drawings. The same reference numbers may be used throughout the drawings to refer to the same or like parts, components, or operations.

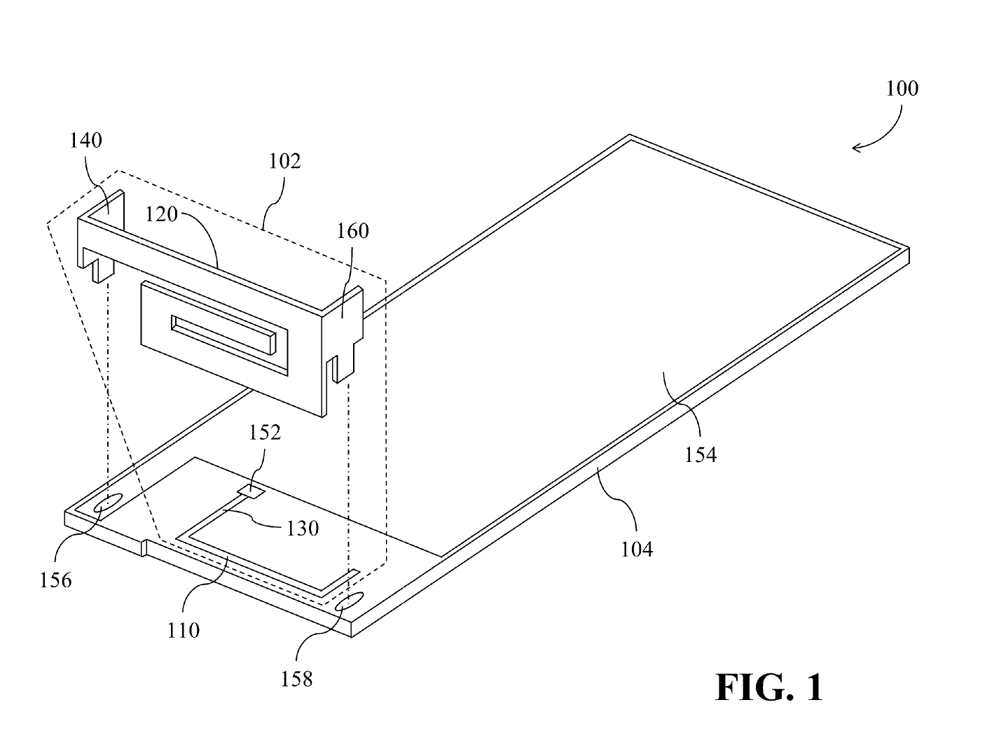

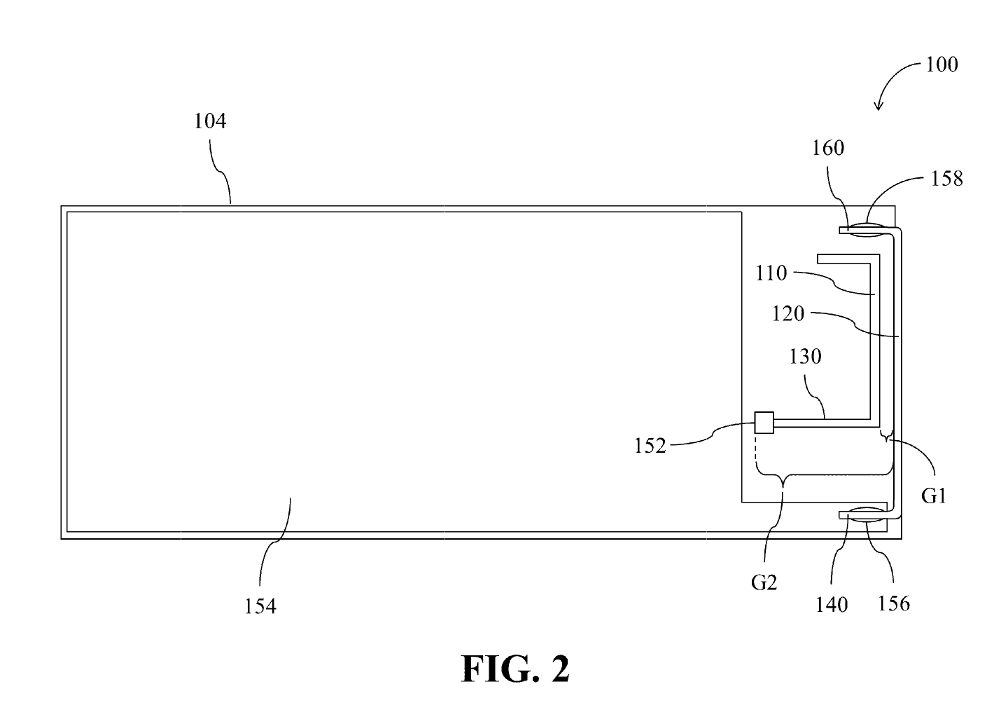

Please refer to FIG. 1 and FIG. 2. FIG. 1 shows a simplified schematic diagram of a wireless communication apparatus 100 according to one embodiment of the present disclosure. FIG. 2 shows a simplified top view of the wireless communication apparatus 100 of FIG. 1 according to one embodiment of the present disclosure. The wireless communication apparatus 100 comprises a dual-band antenna 102 and a circuit board 104. The dual-band antenna 102 comprises a first radiation part 110, a second radiation part 120, a feeding element 130, and a shorting element 140. The circuit board 104 comprises a signal receiving terminal 152, a fixed-voltage region 154, and connecting parts 156 and 158. In this embodiment, the feeding element 130 is coupled with the first radiation part 110, and is utilized for coupling with the signal receiving terminal 152 on the circuit board 104. The shorting element 140 is coupled with the second radiation part 120, and is utilized for coupling with the fixed-voltage region 154 of the circuit board 104. The fixed-voltage region 154 of the circuit board 104 may be a ground plane or a ground terminal, and each of the connecting parts 156 and 158 may be realized with a hole or a solder terminal. In practice, the input impedance of the dual-band antenna 102 may be adjusted by manipulating a gap between the feeding element 130 and the shorting element 140, so as to achieve better impedance matching.

As shown in FIG. 1 and FIG. 2, the first radiation part 110 does not physically contact with the second radiation part 120, and there is a gap between the first radiation part 110 and the second radiation part 120. In this embodiment, the first radiation part 110 is configured to operably receive or transmit signals at a first frequency band, and the second radiation part 120 is configured to operably generate a coupling effect together with the first radiation part 110 to receive or transmit signals at a second frequency band. The second frequency band has a center frequency lower than a center frequency of the first frequency band. In one embodiment, for example, the first frequency band is 5 GHz band, and the second frequency band is 2.4 GHz band.

In practice, the first radiation part 110 may be realized with a monopole antenna formed by a metal strip or a metal sheet, and may be arranged on any layer of the circuit board 104 by means of adhesion, solder, or printing. Alternatively, the first radiation part 110 may be realized with a folded U-shaped dipole antenna, and the two folded radiation sections of the U-shaped dipole antenna may be respectively arranged on different layers of the circuit board 104 (e.g., an upper surface and a lower surface of the circuit board 104), so as to provide a radiation pattern identical or similar to the radiation pattern of the monopole antenna.

The aforementioned second radiation part 120 comprises multiple radiation sections. In practice, the shorting element 140 and the multiple radiation sections of the second radiation part 120 may be respectively formed by conductive materials, and then assembled together. Alternatively, the second radiation part 120 and the shorting element 140 may be formed integrally by stamping or cutting a single metal sheet, so as to reduce the manufacturing complexity and cost, thereby increasing the manufacturing speed and yield rate.

Before the second radiation part 120 is assembled with the circuit board 104 of the wireless communication apparatus 100, the second radiation part 120 may be bent into an appropriate shape, so as to increase the structural rigidity of the second radiation part 120.

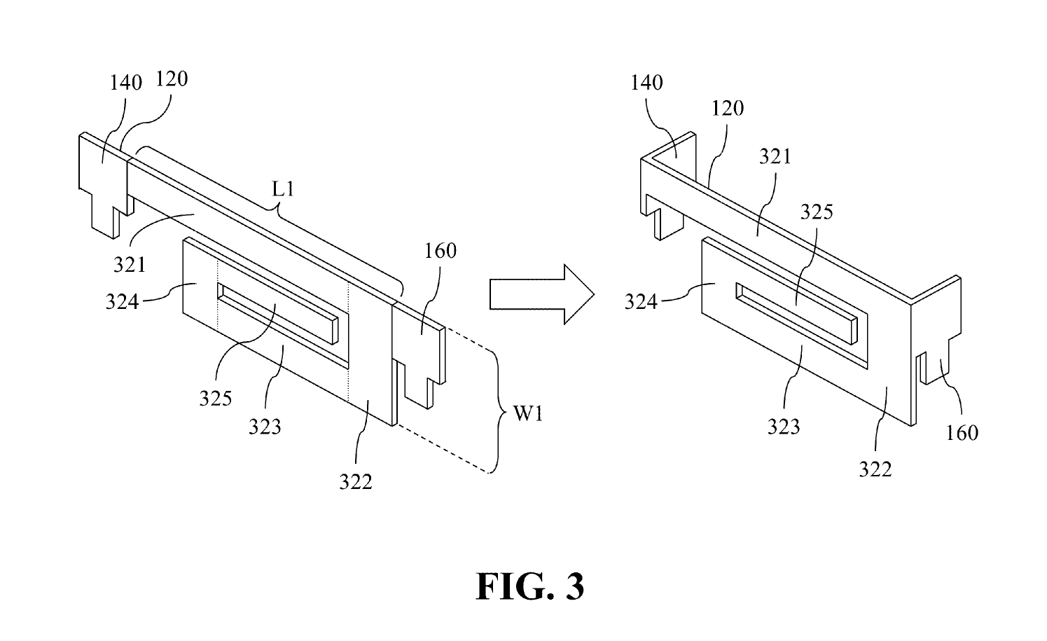

FIG. 3 shows a simplified schematic diagram illustrating a method for producing the second radiation part 120 in FIG. 1 according to one embodiment of the present disclosure. In the embodiment of FIG. 3, the second radiation part 120 and the shorting element 140 are formed integrally with a single metal sheet. The second radiation part 120 comprises a first radiation section 321, a second radiation section 322, a third radiation section 323, a fourth radiation section 324, a fifth radiation section 325, and a supporting part 160. In one embodiment, the second radiation part 120 has a width W1 between 2.8˜5.2 millimeters (e.g., 4.0 millimeters), and the second radiation part 120 has a length L1 between 6.9˜12.8 millimeters (e.g., 9.9 millimeters).

As shown in FIG. 3, the first radiation section 321 is substantially perpendicular to the second radiation section 322, and the fourth radiation section 324 is substantially perpendicular to both the third radiation section 323 and the fifth radiation section 325. In this embodiment, the third radiation section 323 is connected with the second radiation section 322, and the fifth radiation section 325 is positioned between the first radiation section 321 and the third radiation section 323.

Before the second radiation part 120 is assembled with the circuit board 104, the shorting element 140 may be bent toward a first direction to form a predetermined included angle (e.g., any angle between 80˜100 degrees) between the shorting element 140 and the second radiation part 120. Alternatively, the shorting element 140 may be bent toward the first direction to be substantially perpendicular to the second radiation part 120. Similarly, the supporting part 160 may be bent toward the first direction to form a predetermined included angle (e.g., any angle between 80˜100 degrees) between the supporting part 160 and the second radiation part 120. Alternatively, the supporting part 160 may be bent toward the first direction to be substantially perpendicular to the second radiation part 120.

In this embodiment, the multiple radiation sections 321˜325 of the second radiation part 120 are positioned on a first plane under normal operating condition, and an included angle between the first plane and the upper surface of the circuit board 104 is between 65˜115 degrees (e.g. 90 degrees). The shorting element 140 may be substantially parallel or not parallel to the supporting part 160 under normal operating condition. Additionally, the multiple radiation sections 321˜325 of the second radiation part 120 are not positioned on a plane on which the shorting element 140 and the supporting part 160 reside. For example, the shorting element 140 may be positioned on a second plane substantially perpendicular to the first plane. In other words, the second radiation part 120 and the shorting element 140 form a three-dimensional structure under normal operating condition, so as to greatly increase the structural rigidity and the stability of the second radiation part 120, thereby avoiding the second radiation part 120 from deformation during the assembly process and operation.

When the second radiation part 120 is assembled with the circuit board 104, the supporting part 160 is connected with the connecting part 158 to increase the structural rigidity and the stability of the second radiation part 120 after the second radiation part 120 is assembled with the circuit board 104. Additionally, the supporting part 160 may be designed to have a stepped end terminal, so that the second radiation part 120 may be more firmly fixed to the circuit board 104, thereby increasing the structural rigidity and the stability of the second radiation part 120 after the second radiation part 120 is assembled with the circuit board 104.

In the embodiment where the connecting part 156 is a hole, an inner surface of the connecting part 156 may be plated with conductive materials, such as copper, and coupled with the fixed-voltage region 154 of the circuit board 104. Accordingly, when the shorting element 140 is inserted into or soldered to the connecting part 156, the shorting element 140 is coupled with the fixed-voltage region 154.

The connecting part 158 is not conductive with the fixed-voltage region 154. Accordingly, when the supporting part 160 is inserted into or soldered to the connecting part 158, the supporting part 160 is not conductive with the fixed-voltage region 154.

In one embodiment, the feeding element 130 may be directly connected with the signal receiving terminal 152 of the circuit board 104, or may be coupled with the signal receiving terminal 152 of the circuit board 104 through a via hole. The wireless communication apparatus 100 may filter signals received by the feeding element 130, so as to respectively process signals at the first frequency band and signals at the second frequency band simultaneously.

As shown in FIG. 2, at least 40% of the first radiation part 110 is positioned on a first line, and a shortest distance between the first line and the aforementioned first plane on which the radiation sections 321˜325 reside is G1. Additionally, there is a gap G2 between the signal receiving terminal 152 and the first plane. The coupling amount between the first radiation part 110 and the second radiation part 120 varies depending on the distance G1, thereby affecting the matching and the operating frequency of the second radiation part 120. In practice, the distance G1 may be configured to be between 0.35˜0.65 millimeter (e.g., 0.5 millimeter), and the gap G2 may be configured to be between 2.8˜5.2 millimeters (e.g., 4.0 millimeters). In the embodiment of FIG. 2, the first line is substantially parallel to the first plane, i.e., at least a portion of the first radiation part 110 is not positioned on the aforementioned first plane.

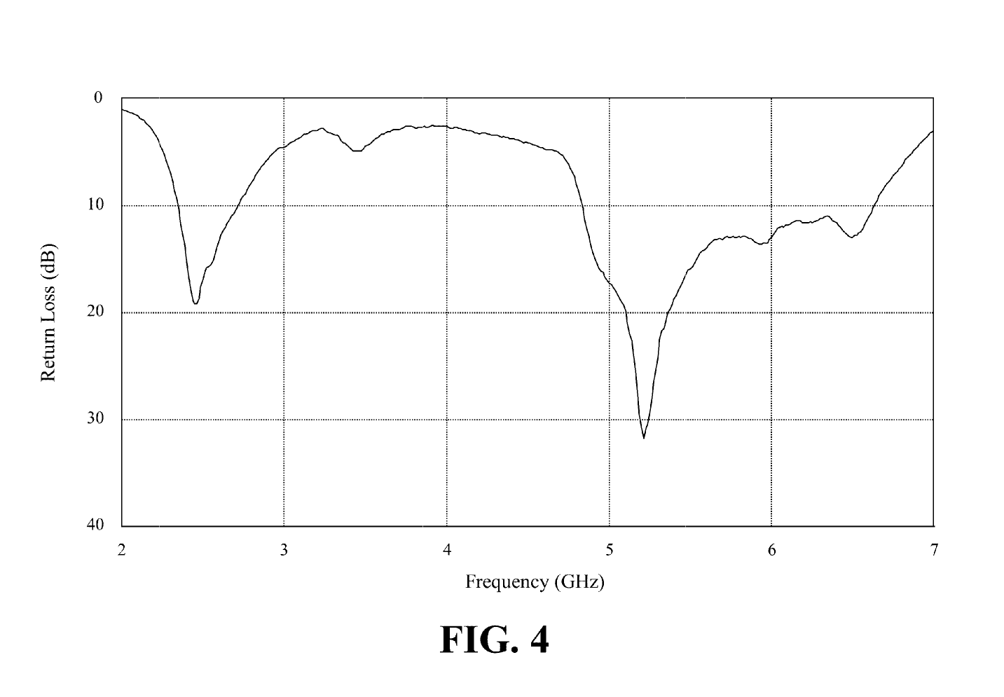

FIG. 4 shows a simplified schematic diagram of operating characteristics of the dual-band antenna 102 in FIG. 1 according to one embodiment of the present disclosure. As described previously, the second radiation part 120 generates the coupling effect with the first radiation part 110. The coupling effect between the first radiation part 110 and the second radiation part 120 causes a triple harmonic of the second radiation part 120 to move toward lower frequency band, and to merge with an original effective frequency band of the first radiation part 110 to thereby synthesize the first frequency band. As a result, the first frequency band is enabled have a bandwidth greater than a bandwidth of the original effective frequency band of the first radiation part 110. For example, in the embodiment where the second radiation part 120 operates at 2.4 GHz band and the first radiation part 110 operates at 5 GHz band, the disclosed dual-band antenna 102 is capable of simultaneously supporting dual-band operations in both 2.4˜2.48 GHz band and 5.1˜5.85 GHz band. Obviously, the effective bandwidth of the dual-band antenna 102 in the 5 GHz band is much greater than that of the traditional miniaturized dual-band antenna. Accordingly, the disclosed dual-band antenna 102 is suitable for applications in any kind of compact wireless communication apparatus, such as a USB adapter or a mobile phone, to enable the wireless communication apparatus to have a greater operating bandwidth in high frequency band.

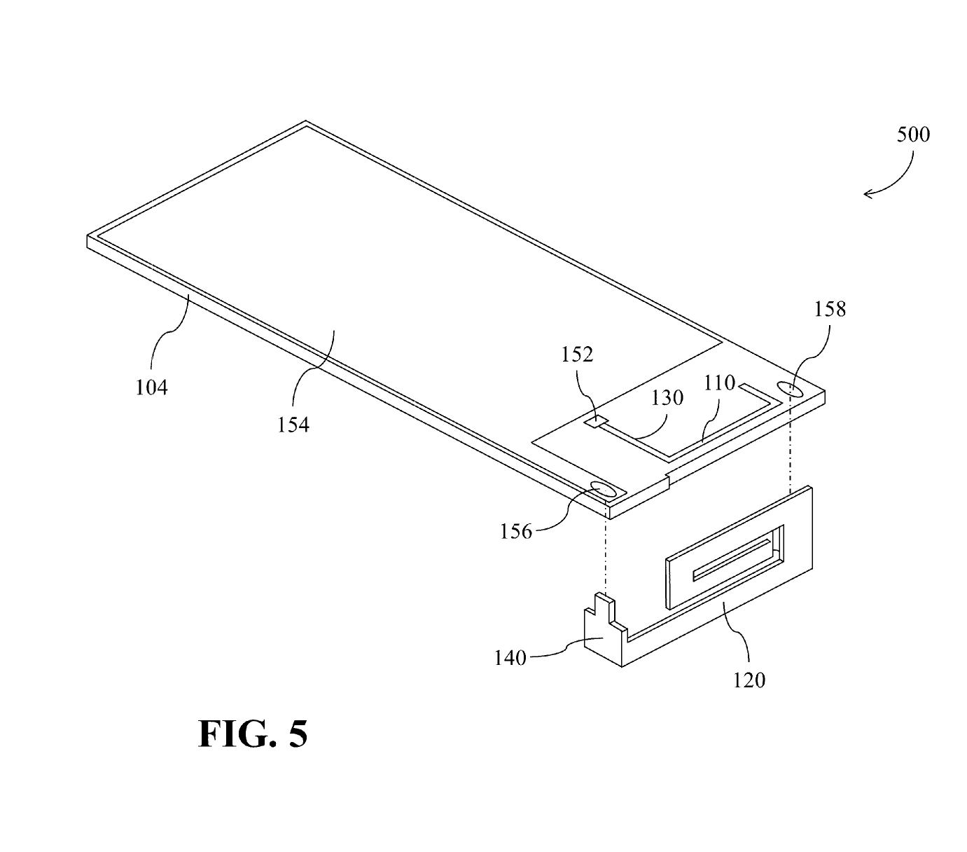

FIG. 5 shows a simplified schematic diagram of a wireless communication apparatus 500 according to another embodiment of the present disclosure. The wireless communication apparatus 500 is very similar to the aforementioned wireless communication apparatus 100 of FIG. 1. One difference between the two embodiments is that the shorting element 140 of the wireless communication apparatus 500 and the supporting part 160 of the second radiation part 120 are respectively bent toward a direction different from the aforementioned first direction in the embodiment of FIG. 1. In the embodiment of FIG. 5, the shorting element 140 may be bent toward an opposite direction of the first direction to form a predetermined included angle (e.g., any angle between 80˜100 degrees) between the shorting element 140 and the second radiation part 120. Alternatively, the shorting element 140 may be bent toward the opposite direction to be substantially perpendicular to the second radiation part 120. Similarly, the supporting part 160 may be bent toward the opposite direction to form a predetermined included angle (e.g., any angle between 80˜100 degrees) between the supporting part 160 and the second radiation part 120. Alternatively, the supporting part 160 may be bent toward the opposite direction to be substantially perpendicular to the second radiation part 120.

Another difference between the wireless communication apparatus 500 and the wireless communication apparatus 100 is that the second radiation part 120 of the wireless communication apparatus 500 is assembled upward with the circuit board 104 from the bottom side of the circuit board 104. Although the bending direction of the shorting element 140 and the supporting part 160 in the embodiment of FIG. 5 is different from that in the embodiment of FIG. 1, the descriptions regarding the implementations, operation mechanism, and related advantages of the first radiation part 110 and the second radiation part 120 of FIG. 1 are also applicable to the embodiment of FIG. 5.

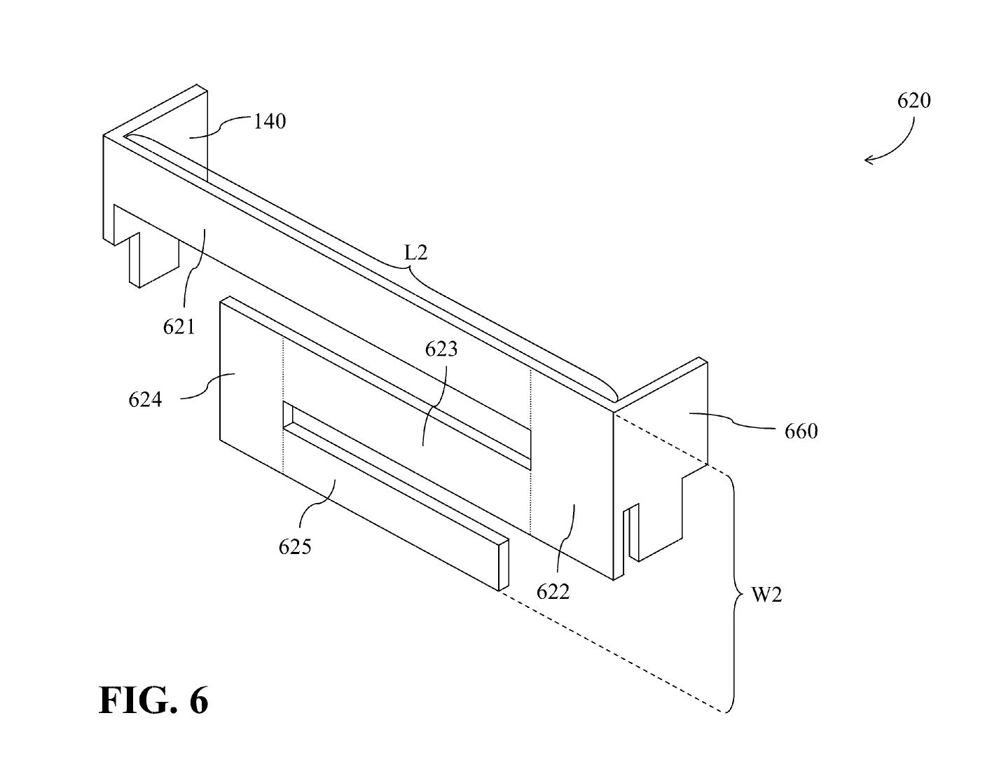

FIG. 6 shows a simplified schematic diagram of a second radiation part 620 according to another embodiment of the present disclosure. In the embodiment of FIG. 6, the second radiation part 620 comprises a first radiation section 621, a second radiation section 622, a third radiation section 623, a fourth radiation section 624, a fifth radiation section 625, and a supporting part 660. In this embodiment, the second radiation part 620 has a width W2 between 2.8˜5.2 millimeters (e.g. 4.2 millimeters), the second radiation part 620 has a length L2 between 6.9˜12.8 millimeters (e.g. 9.9 millimeters), and the aforementioned shorting element 140 is coupled with the second radiation part 620.

As shown in FIG. 6, the first radiation section 621 is substantially perpendicular to the second radiation section 622, and the fourth radiation section 624 is substantially perpendicular to both the third radiation section 623 and the fifth radiation section 625. In this embodiment, the third radiation section 623 is connected with the second radiation section 622, and the third radiation section 623 is positioned between the first radiation section 621 and the fifth radiation section 625.

In this embodiment, the multiple radiation sections 621˜625 of the second radiation part 620 are positioned on a first plane under normal operating condition, but the shorting element 140 and the supporting part 660 are not positioned on the first plane. For example, the shorting element 140 may be positioned on a second plane substantially perpendicular to the first plane. Additionally, the shorting element 140 may be substantially parallel or not parallel to the supporting part 660 under normal operating condition. In other words, the second radiation part 620 and the shorting element 140 form a three-dimensional structure under normal operating condition, so as to greatly increase the structural rigidity and the stability of the second radiation part 620, thereby avoiding the second radiation part 620 from deformation during the assembly process and operation.

Although the shape of the second radiation part 620 is somewhat different from the shape of the second radiation part 120, the descriptions regarding the implementations, operation mechanism, and related advantages of the dual-band antenna 102 formed by the first radiation part 110 and the second radiation part 120 are also applicable to the dual-band antenna formed by the first radiation part 110 and the second radiation part 620.

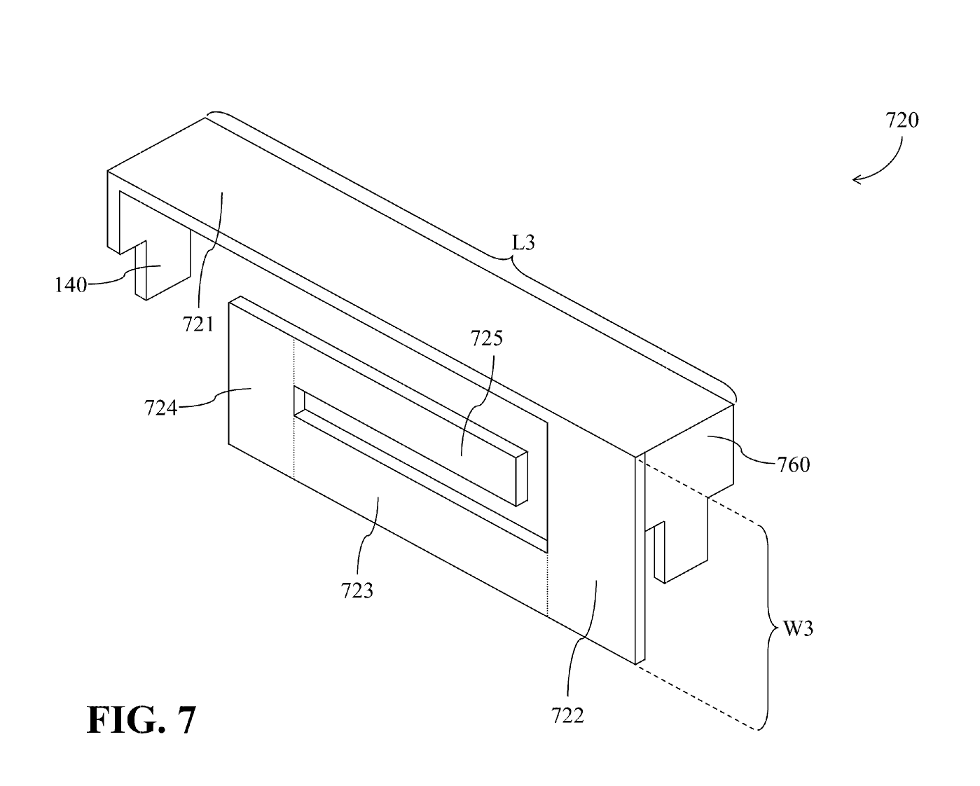

FIG. 7 shows a simplified schematic diagram of a second radiation part 720 according to another embodiment of the present disclosure. In the embodiment of FIG. 7, the second radiation part 720 comprises a first radiation section 721, a second radiation section 722, a third radiation section 723, a fourth radiation section 724, a fifth radiation section 725, and a supporting part 760. In this embodiment, the second radiation part 720 has a width W3 between 2.8˜5.2 millimeters (e.g. 3.5 millimeters), the second radiation part 720 has a length L3 between 6.9˜12.8 millimeters (e.g. 9.9 millimeters), and the aforementioned shorting element 140 is coupled with the second radiation part 720.

As shown in FIG. 7, the first radiation section 721 is substantially perpendicular to the second radiation section 722, and the fourth radiation section 724 is substantially perpendicular to both the third radiation section 723 and the fifth radiation section 725. In this embodiment, the third radiation section 723 is connected with the second radiation section 722, and the fifth radiation section 725 is positioned between the first radiation section 721 and the third radiation section 723.

In this embodiment, the second radiation section 722, the third radiation section 723, the fourth radiation section 724, and the fifth radiation section 725 are positioned on a first plane under normal operating condition, the first radiation section 721 is positioned on a second plane substantially perpendicular to the first plane, but the shorting element 140 and the supporting part 760 are not positioned on the aforementioned first plane nor the second plane. For example, the shorting element 140 may be positioned on a third plane substantially perpendicular to both the first plane and the second plane. Additionally, the shorting element 140 may be substantially parallel or not parallel to the supporting part 760 under normal operating condition. In other words, the second radiation part 720 and the shorting element 140 form a three-dimensional structure under normal operating condition, so as to greatly increase the structural rigidity and the stability of the second radiation part 720, thereby avoiding the second radiation part 720 from deformation during the assembly process and operation.

Although the shape of the second radiation part 720 is somewhat different from the shape of the second radiation part 120, the descriptions regarding the implementations, operation mechanism, and related advantages of the dual-band antenna 102 formed by the first radiation part 110 and the second radiation part 120 are also applicable to the dual-band antenna formed by the first radiation part 110 and the second radiation part 720.

In practice, the supporting parts 160, 660 and 760 of the aforementioned embodiments may be omitted to further reduce the required material of the second radiation part 120, 620, or 720.

As described previously, the coupling effect generated by the first radiation part 110 and the second radiation part 120, 620, or 720 causes the triple harmonic of the second radiation part 120, 620, or 720 to move toward the lower frequency band, and to merge with the original effective frequency band of the first radiation part 110 to thereby synthesize the first frequency band with a greater bandwidth. As a result, the disclosed dual-band antenna for operating at multiple frequency bands is enabled to have good antenna radiation characteristics, compact size, and sufficient bandwidth.

Since each of the second radiation parts 120, 620, and 720 could be formed integrally, and thus the disclosed second radiation part may be realized by bending a single metal conductor into an appropriate shape. In addition, the disclosed dual-band antennas have the merits of low cost and easy to manufacture and assemble as they could be directly soldered to or inserted into a circuit board of an electronic device.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.” The phrases “be coupled with,” “couples with,” and “coupling with” are intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The term “and/or” may comprise any and all combinations of one or more of the associated listed items. In addition, the singular forms “a,” “an,” and “the” herein are intended to comprise the plural forms as well, unless the context clearly indicates otherwise.

Throughout the description and claims, the term “element” contains the concept of component, layer, or region.

In the drawings, the size and relative sizes of some elements may be exaggerated or simplified for clarity. Accordingly, unless the context clearly specifies, the shape, size, relative size, and relative position of each element in the drawings are illustrated merely for clarity, and not intended to be used to restrict the claim scope.

For the purpose of explanatory convenience in the specification, spatially relative terms, such as “on,” “above,” “below,” “beneath,” “higher,” “lower,” “upward,” “downward,” and the like, may be used herein to describe the function of a particular element or to describe the relationship of one element to another element(s) as illustrated in the drawings. It will be understood that the spatially relative terms are intended to encompass different orientations of the element in use, in operations, or in assembly in addition to the orientation depicted in the drawings. For example, if the element in the drawings is turned over, elements described as “on” or “above” other elements would then be oriented “under” or “beneath” the other elements. Thus, the exemplary term “beneath” can encompass both an orientation of above and beneath.

Other embodiments of the invention will be apparent to those skilled in the art from consideration of the specification and practice of the invention disclosed herein. It is intended that the specification and examples be considered as exemplary only, with a true scope and spirit of the invention indicated by the following claims.

What is claimed is:

1. A dual-band antenna of a wireless communication apparatus, comprising:
a first radiation part, configured to operably receive or transmit signals at a first frequency band;
a second radiation part, configured to operably generate a coupling effect together with the first radiation part to receive or transmit signals at a second frequency band having a center frequency lower than a center frequency of the first frequency band, wherein the second radiation part comprises multiple radiation sections, and at least one of the multiple radiation sections is positioned on a first plane;
a feeding element, coupled with the first radiation part, for coupling with a signal receiving terminal of the wireless communication apparatus; and
a shorting element, coupled with the second radiation part, for coupling with a fixed-voltage region of the wireless communication apparatus;
wherein the first radiation part does not physically contact with the second radiation part, and at least a portion of the first radiation part is not positioned on the first plane.

2. The dual-band antenna of claim 1, wherein the first radiation part is a monopole antenna or a bipolar antenna.

3. The dual-band antenna of claim 1, wherein the coupling effect between the first radiation part and the second radiation part causes a triple harmonic of the second radiation part to move toward lower frequency band, and to merge with an original effective frequency band of the first radiation part to thereby synthesize the first frequency band.

4. The dual-band antenna of claim 1, wherein the second radiation part comprises a first radiation section, a second radiation section, a third radiation section, a fourth radiation section, and a fifth radiation section which are positioned on the first plane.

5. The dual-band antenna of claim 4, wherein the first radiation part is positioned on a plane substantially perpendicular to the first plane.

6. The dual-band antenna of claim 5, wherein the first radiation section is substantially perpendicular to the second radiation section, and the fourth radiation section is substantially perpendicular to both the third radiation section and the fifth radiation section.

7. The dual-band antenna of claim 6, wherein the third radiation section is connected with the second radiation section, and the fifth radiation section is positioned between the first radiation section and the third radiation section.

8. The dual-band antenna of claim 6, wherein the third radiation section is connected with the second radiation section, and the third radiation section is positioned between the first radiation section and the fifth radiation section.

9. The dual-band antenna of claim 1, wherein the second radiation part comprises a first radiation section, a second radiation section, a third radiation section, a fourth radiation section, and a fifth radiation section;
wherein the second radiation section, the third radiation section, the fourth radiation section, and the fifth radiation section are positioned on the first plane, the first radiation section is positioned on a second plane, and the first plane is not parallel to the second plane.

10. The dual-band antenna of claim 9, wherein the first plane is substantially perpendicular to the second plane.

11. The dual-band antenna of claim 10, wherein the shorting element is positioned on a third plane, and the third plane is substantially perpendicular to the first plane and is also substantially perpendicular to the second plane.

12. The dual-band antenna of claim 9, wherein the first radiation section is substantially perpendicular to the second radiation section, and the fourth radiation section is substantially perpendicular to both the third radiation section and the fifth radiation section.

13. The dual-band antenna of claim 12, wherein the third radiation section is connected with the second radiation section, and the fifth radiation section is positioned between the first radiation section and the third radiation section.

14. The dual-band antenna of claim 1, wherein a portion of the first radiation part is positioned on a first line, and a shortest distance between the first line and the first plane is between 0.35˜0.65 millimeter.

15. The dual-band antenna of claim 14, wherein the first line is substantially parallel to the first plane.

16. The dual-band antenna of claim 14, wherein at least 40% of the first radiation part is positioned on the first line.

17. The dual-band antenna of claim 1, wherein an included angle between the first plane and an upper surface of a circuit board of the wireless communication apparatus is between 65˜115 degrees.

18. The dual-band antenna of claim 1, wherein a gap between the signal receiving terminal and the first plane is between 2.8˜5.2 millimeters.

19. The dual-band antenna of claim 1, wherein the second radiation part has a width between 2.8˜5.2 millimeters.

20. The dual-band antenna of claim 1, wherein the second radiation part has a length between 6.9˜12.8 millimeters.
